(19) United States
(12) Patent Application Publication
(10) Pub. No.: US 2024/0197105 A1
(43) Pub. Date: Jun. 20, 2024

(54) COLD BREW COFFEE BREWING SYSTEM

(71) Applicants: Bruce Parks, Carmichael, CA (US); Brian Schyberg, Sacramento, CA (US)

(72) Inventors: Bruce Parks, Carmichael, CA (US); Brian Schyberg, Sacramento, CA (US)

(21) Appl. No.: 18/085,447

(22) Filed: Dec. 20, 2022

(51) Int. Cl. A47J 31/22; A47J 31/46

(52) U.S. Cl. CPC A47J 31/22; A47J 31/461; A47J 31/468

(57) ABSTRACT

A cold brew coffee brewing system is disclosed including a cold brew coffee brewing machine and an optional centrifugal coffee beverage extractor. The coffee brewing machine has a brewing basket within which water is added to ground coffee to create a coffee beverage. The coffee beverage is chilled and continuously circulated by a pump through U-shaped tubing from a coffee reservoir below the bottom of the brewing basket to the top of the brewing basket. The coffee slurry within the brewing basket of the coffee brewing machine is relocated to a coffee slurry container of the centrifugal coffee beverage extractor. The extractor includes a motor to impart a rotational force to the coffee slurry container and to the coffee slurry therewithin. Coffee beverage remaining in the slurry is centrifugally extracted and drained from the coffee slurry container to maximize the coffee beverage yield.

### BACKGROUND OF THE INVENTION

### 1. Field of the Invention

This invention relates to a cold brew coffee brewing system having a cold brew coffee brewing machine and an optional centrifugal coffee extractor. The cold brew coffee brewing machine includes a coffee filled brewing basket from which a coffee liquid is produced and piping through which chilled coffee liquid is pumped from a chiller and circulated back to the brewing basket to allow the chilled liquid to continually percolate through the coffee. The centrifugal coffee extractor has a rotatable coffee slurry container in which to receive coffee slurry removed from the brewing basket and to which a rotational force is applied to cause the coffee slurry container to spin and retained coffee liquid to be centrifugally extracted from the slurry.

### 2. Background Art

Coffee is traditionally brewed by mixing boiling hot water with ground coffee beans. Coffee can also be made by mixing cold or room temperature water with ground coffee beans. This process is referred to as cold brewing, and the resultant coffee beverage is known as cold brewed coffee. Unlike hot brewing, the cold brewing process requires several hours in order to be able to extract the desired compounds from the ground coffee beans. However, the cold brewing process is also known to produce a coffee beverage with unique flavor characteristics.

Several problems are associated with most cold brewing systems. In particular, cold brewing machines allow the coffee grounds to sit statically in a still water bath at room temperature without being subjected to agitation or stirring of any kind. The foregoing raises health concerns with respect to food products that sit at room temperature for extended periods of time. Moreover, after the cold brewing process has been completed, the used and now fully saturated coffee grounds slurry contains a significant amount of usable coffee liquid retained therein. This remaining coffee liquid is typically discarded along with the used coffee grounds slurry which results in an inefficient coffee yield.

### SUMMARY OF THE INVENTION

In general terms, a cold brew coffee brewing system is disclosed including a cold brew coffee brewing machine and an optional centrifugal coffee extractor. The coffee brewing machine has a coffee brewing basket that is surrounded by a coffee collection container and suspended above a coffee reservoir at the bottom of the coffee collection container. A flow-through filter bag containing ground coffee beans is located in the coffee brewing basket, and fresh water is poured into the brewing basket to flow through the ground coffee within the filter bag. A coffee liquid flows out of the brewing basket and into the coffee reservoir by way of a funnel at the bottom of the brewing basket. The coffee liquid is supplied from the coffee reservoir by way of an inlet strainer to a coffee chiller where the coffee liquid is chilled. The chilled coffee liquid is pumped through U-shaped coffee circulation piping from the coffee chiller upwardly through the coffee collection container to extend above the coffee brewing basket and then downwardly so as to lie in spaced axial alignment with a perforated top of the coffee brewing basket to allow the chilled coffee liquid to continuously percolate through the ground coffee within the filter bag until a desired flavor is achieved.

The optional centrifugal coffee extractor has a rotatable coffee slurry container that is surrounded by a stationary coffee pouring vessel. At the conclusion of the cold coffee brewing process, the flow-through filter bag is removed from the coffee brewing basket of the cold brew coffee brewing machine and relocated to the coffee slurry container of the centrifugal coffee extractor. A slurry consisting of a mixture of ground coffee and water remains within the filter bag. A motor is coupled to the rotatable coffee slurry container so as to apply a rotational force by which to cause the coffee slurry container to spin within the coffee pouring vessel. By virtue of the foregoing, coffee liquid that is retained by the slurry is centrifugally extracted therefrom. The extracted coffee liquid flows into the coffee pouring vessel through perforations formed in the coffee slurry container whereby to increase the coffee beverage yield. The additional coffee liquid is removed from the coffee pouring vessel by way of a spout that projects outwardly therefrom.

### BRIEF DESCRIPTION OF THE DRAWINGS

FIG. 1 shows a cold brew coffee brewing machine for making cold brewed coffee having coffee circulation piping through which chilled coffee liquid is pumped and returned to a coffee brewing basket so that the liquid will continuously percolate through ground coffee beans within the brewing basket;

FIG. 2 is an exploded view to illustrate details of the cold brew coffee brewing machine shown in FIG. 1;

FIG. 3 is an exploded perspective view to illustrate the coffee circulation piping of the cold brew coffee brewing machine shown in FIG. 1;

FIG. 4 is a side view of the cold brew coffee brewing machine shown in FIG. 1;

FIG. 5 shows an optional centrifugal coffee extractor that receives coffee slurry removed from the cold brew coffee brewing machine of FIG. 1 and then spins the slurry so that retained coffee liquid can be centrifugally extracted from the slurry to increase the coffee yield; and

FIG. 6 is a side view of the centrifugal coffee extractor shown in FIG. 5.

### DESCRIPTION OF THE PREFERRED EMBODIMENT

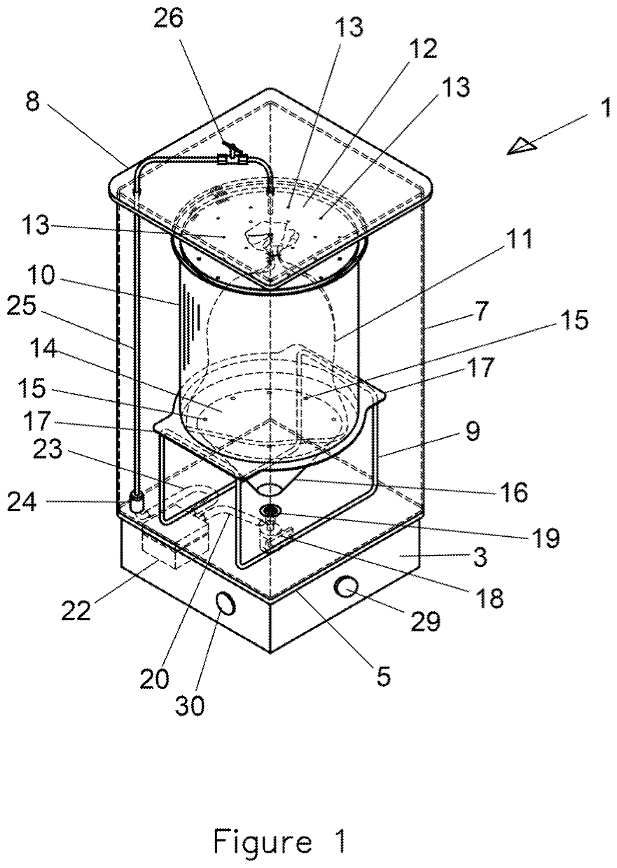

Referring initially to FIGS. 1-4 of the drawings, there is shown a cold brew coffee brewing machine 1 from a cold brew coffee brewing system that is capable of making cold brewed coffee as opposed to traditional coffee that is brewed by mixing hot water with ground coffee beans. The cold brew coffee brewing system described herein is especially adapted to extract the maximum flavor and liquid yield from the coffee. The coffee brewing machine 1 is sized to sit on a countertop or stand upright on a floor.

The cold brew coffee brewing machine 1 of the cold brew coffee brewing system herein disclosed includes a hollow base 3 having a platform 5 extending across the top thereof. A water-tight coffee collection container 7 having a detachable lid 8 sits on the base 3 so as to stand upwardly from the platform 5. A brewing basket suspension stand 9 that is located inside the coffee collection container 7 lays on the platform 5 above the base 3. The brewing basket suspension stand 9 is configured to suspend a cylindrical brewing basket 10 above the platform 5.

The brewing basket 10 is filled with a removable flow-through filter bag 11 that contains a fresh supply of ground coffee beans. However, the filter bag 11 can be replaced by a removable coffee filled pod or cartridge. A recirculated coffee distribution head 12 covers the top of brewing basket 10. The coffee distribution head 12 has a plurality of perforations 13 formed therein. Extending across the bottom of the brewing basket 10 opposite the coffee distribution head 12 is a basket closure 14. A series of coffee flow-through holes 15 are formed in the basket closure 14. Extending downwardly from the basket closure 14 at the bottom of the brewing basket 10 is a downwardly sloping funnel 16 having integral funnel platforms 17 projecting from opposite sides thereof. The funnel 16 lies in fluid communication with the interior of the brewing basket 10 by way of the coffee flow-through holes 15 in the basket closure 14.

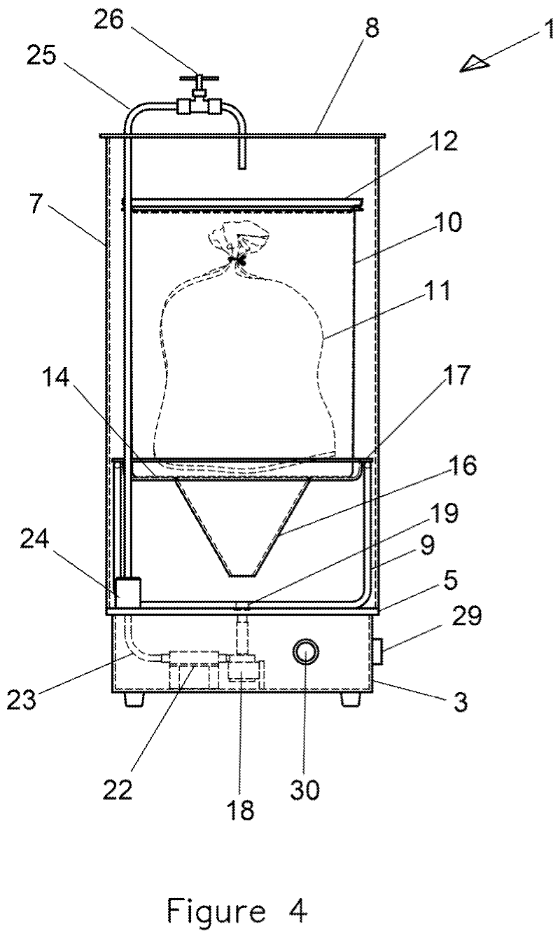

Located within the hollow base 3 of the coffee brewing machine 1 below platform 5 is a pump 18 (best shown in FIG. 4). An inlet strainer 19 is located above platform 5 in spaced axial alignment with the funnel 16 below the brewing basket 10. The funnel platforms 17 position the funnel 16 on the stand 9 to maintain its axial alignment with strainer 19. The strainer 19 prevents particulate matter within the coffee liquid from flowing into the pump 18. The pump 18 is coupled by chiller inlet tubing 20 to a chiller 22 that is also located within the hollow base 3 below platform 5. By way of example, the chiller 22 includes a heat exchanger such as a solid state Peltier cooling device that is capable of lowering the temperature of the coffee liquid in order to suit the taste of the user and comply with safety requirements. Chiller outlet tubing 23 runs from the chiller 22 to a soft coupler 24 where it is connected to a U-shaped coffee circulation pipe 25 or other suitable tubing. The coffee circulation pipe 25 runs upwardly within the coffee collection container 7 so as to extend outwardly through the lid 8 at which to lie above the top of the coffee collection container 7. The U-shaped coffee circulation pipe 25 then extends downwardly through the lid 8 and into the coffee collection container 7 to establish a coffee return path to the brewing basket 10. As is also best shown in FIG. 4, a manually operated flow control valve 26 is located within the coffee circulation pipe 25 above the lid 8 of container 7 to be accessible to a user to regulate the flow of the chilled coffee liquid produced by the chiller 22.

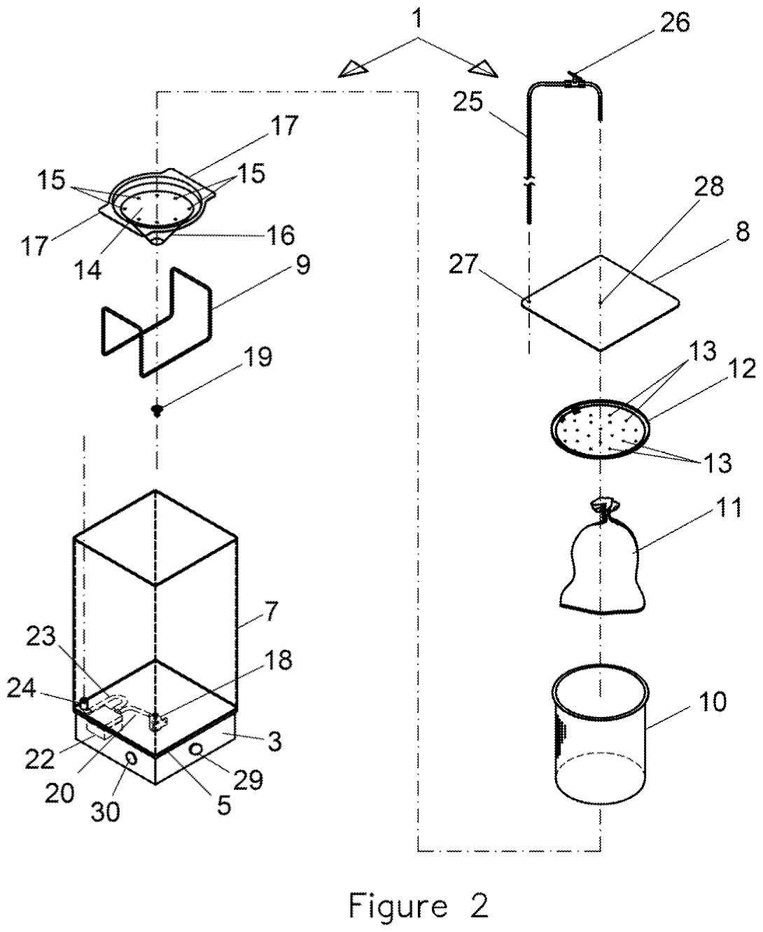

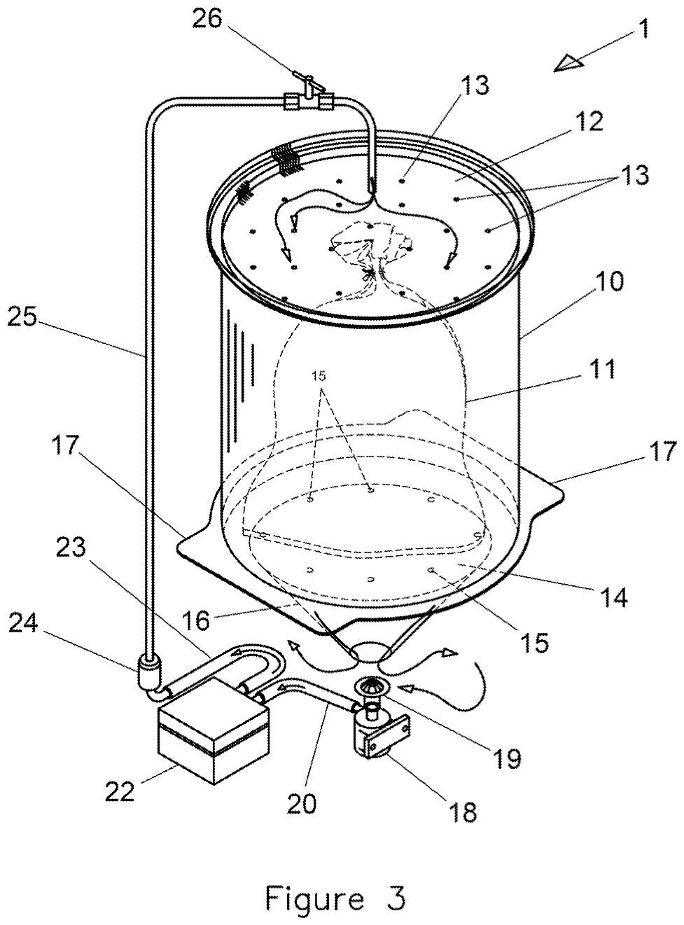

As is best shown in FIG. 2, the U-shaped coffee circulation pipe 25 that runs upwardly within the coffee collection container 7 from the chiller 22 initially projects through a first hole 27 that is formed in the lid 8. The coffee circulation pipe 25 then turns downwardly from above the coffee collection container 7 and projects through a second hole 28 that is also formed in lid 8. The downturned coffee circulation pipe 25 runs through the coffee collection container 7 until it is located in spaced axial alignment with the perforated coffee distribution head 12 at the top of the brewing basket 10 (best shown in FIG. 3).

Operation of the pump is manually controlled by an on/off power switch 29 that is accessible outside the base 3 of the coffee machine 1. Operation of the chiller 22 is manually controlled by on/off power switch 30 that is also accessible outside the base 3 of machine 1.

Details of the cold brew coffee brewing process are now described while continuing to refer to FIGS. 1-4. The filter bag 11 of ground coffee beans is initially placed inside the brewing basket 10 that is held by the basket suspension stand 9 seated on platform 5 above the base 3 of the cold coffee brewing machine 1. With the lid 8 detached from the coffee container 7, fresh water is poured into the brewing basket 10 by way of the perforations 13 formed in the coffee distribution head 12. The water percolates through the ground coffee in the bag 11, and the resulting coffee liquid that is extracted from the beans runs out of the brewing basket 10 by way of the coffee flow-through holes 15 formed in the basket closure 14. The coffee liquid then runs through the funnel 16 at the bottom of the basket 10. The coffee liquid is collected within a brew reservoir at the bottom of the coffee container 7 of the coffee brewing machine 1. By virtue of its conical shape, the coffee liquid will drip gently down the funnel 16 from the bottom of brewing basket 10 into the brew reservoir within the coffee container 7 such that the buildup of foam is advantageously avoided.

The coffee liquid that is collected within the brew reservoir is supplied to the pump 18 below platform 5 by way of the inlet strainer 19. The pump on/off switch 29 is pushed on, whereby the coffee liquid is pumped from the brew reservoir to the chiller 22 through the chiller inlet tubing 20. After the chiller on/off switch 30 is pushed on, chilled coffee liquid is pumped by way of the chiller outlet tubing 23 into the U-shaped coffee circulation pipe 25 that extends upwardly within the coffee container 7 and outwardly through the lid 8 thereof where the coffee circulation pipe 25 bends downwardly through the lid 8 by which to lie in spaced alignment above the coffee distribution head 12 at the top of the brewing basket 10.

Thus, the coffee liquid that is drained by the pump 18 from the brew reservoir at the bottom of the coffee container 7 is circulated through pipe 25 and returned to the brewing basket 10 so that the liquid will continuously percolate through the ground coffee beans within the filter bag 11 inside the basket. The resulting coffee liquid that is extracted from the beans and runs out of the brewing basket 10 at the funnel 16 is once again collected within the brew reservoir, and the pumping, chilling and circulation steps are repeated until a desirable brewed cold coffee beverage is created. The brew time is a matter of choice in order to produce a corresponding variety of flavor profiles.

When the user has determined that enough time has passed to achieve the desired brew qualities such as color, consistency, coffee compound extraction and flavor profile, the continuous coffee circulation can be ended by turning off the pump on/off switch 29. The circulation pipe 25 can then be lifted out of the hole 28 in the lid 8 and rotated within the coupler 24 away from the lid so as to lie outside the coffee container 7. The pump on/off switch 29 can once again be turned on at which time the pump 18 will pump the coffee liquid from the brew reservoir within the container 7 through the circulation pipe 25 and into an awaiting receptacle to provide coffee beverage to a user.

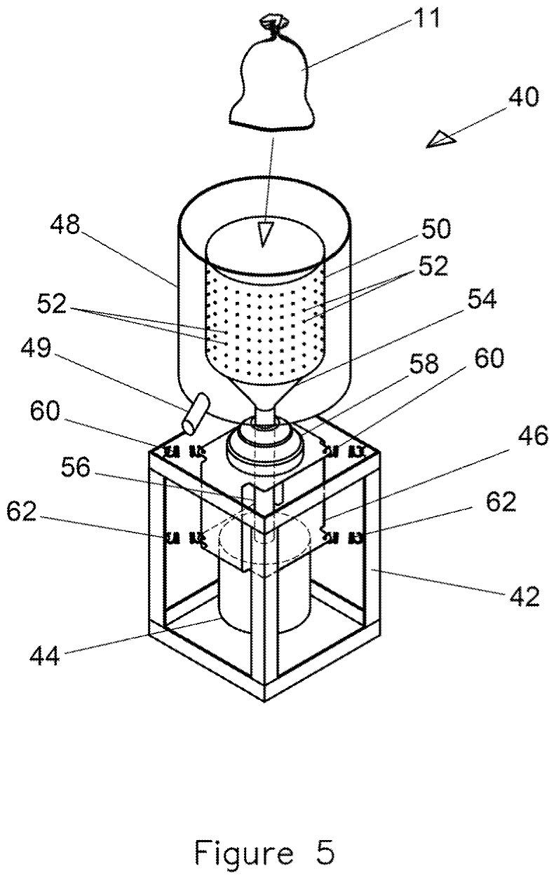

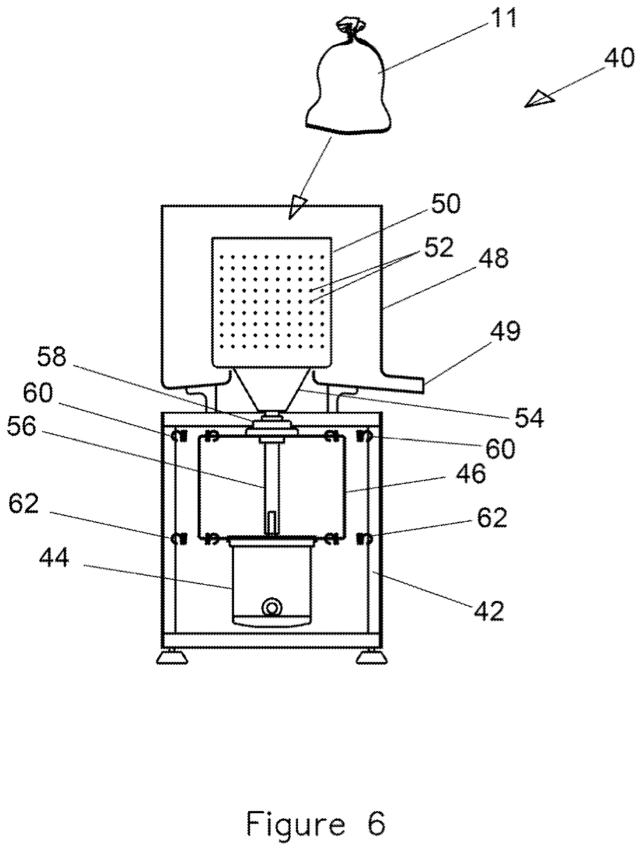

At the conclusion of the cold coffee brewing process described above, the lid 8 is separated from the coffee container 7, and the coffee distribution head 12 is removed from the brewing basket 10. The filter bag 11 with the ground coffee therewithin is now removed from the brewing basket 10 and relocated to an optional centrifugal coffee extractor. Referring in this regard to FIGS. 5 and 6 of the drawings, the centrifugal coffee extractor 40 is shown having an external main frame 42. A motor 44 and an internal motor frame 46 that lies above the motor 44 are surrounded by the external main frame 42.

Seated on top of the main frame 42 is a stationary coffee pouring vessel 48 having a spout 49 projecting outwardly therefrom. Located within the coffee pouring vessel 48 is a rotatable coffee slurry container 50. The coffee slurry container 50 has perforations 52 formed therein by which the interior of the container 50 communicates with the interior of the coffee pouring vessel 48 within which container 50 is located. Attached to the bottom of the slurry container 50 is a conical shaft adapter 54. The shaft adapter 54 is connected to a motor shaft 56 that runs through a shaft support bearing 58 atop the motor frame 46. The motor shaft 56 runs through the motor frame 46 within the main frame 42 where it is coupled to the motor 44. An operation of the motor 44 causes a rotation of the shaft 56 which is imparted to the shaft adapter 54 and to the coffee slurry container 50 within the coffee pouring vessel 48.

Prior to the operation of the motor 44, the coffee filter bag 11 that was removed from the brewing basket 10 of the cold brew coffee brewing machine 1 at the conclusion of the cold brewing process is placed into the rotatable coffee slurry container 50 of the centrifugal coffee extractor 40. In this case, the filter bag 11 is filled with saturated ground coffee slurry. When the motor 44 is energized, the motor shaft 56 and the rotatable coffee slurry container 50 coupled thereto will spin at a high speed. The centrifugal force generated by the rotating coffee slurry container 50 is transferred to the filter bag 11, whereby much of the liquid that remains trapped within the saturated ground coffee slurry is centrifugally extracted. The extracted liquid is identical to the cold brewed coffee produced earlier by the cold brew coffee brewing machine 1 shown in FIGS. 1-4. The extracted liquid drips through the perforations 52 formed in the coffee slurry container 50 for receipt by the coffee pouring vessel 48. Accordingly, an additional supply of cold brewed coffee can be poured from the coffee pouring vessel 48 via the spout 49 projecting therefrom.

It may therefore be appreciated that the centrifugal coffee extractor 40 of FIGS. 5 and 6 is particularly advantageous for use in a cold brew coffee brewing system to increase the yield of the cold brew when compared with conventional cold brewing techniques. However, it is to be understood that the cold brew coffee brewing machine 1 of FIGS. 1-4 can be used as an independent stand-alone machine without the addition of the optional centrifugal extractor 40.

The centrifugal coffee extractor 40 of FIGS. 5 and 6 is provided with a suspension system that is adapted to reduce vibrations and compensate for any mechanical imbalances that may occur as a consequence of rotational forces generated when the motor 44 operates below the motor frame 46 to cause the motor shaft 56 to rotate within the motor frame and the coffee slurry container 50 to spin within the coffee pouring vessel 48. The suspension system includes, but is not limited to, a pair of upper force dissipating springs 60 that stretch from the motor frame 46 to respective opposite sides of the main frame 42. The suspension system also includes, but is not limited to, a pair of lower force dissipating springs 62 that also stretch from the motor frame 46 to respective opposite sides of the main frame 42 so that the lower force dissipating springs 62 lie inside the main frame 42 and below the upper force dissipating springs 60.

1. A cold brew coffee brewing system including a cold brew coffee brewing machine having a top, a bottom and a coffee reservoir located at the bottom, said cold brew coffee brewing machine comprising:
a coffee brewing basket in which ground coffee is placed, said coffee brewing basket receiving a supply of water to be mixed with the ground coffee within said coffee brewing basket in order to create a coffee beverage, said coffee brewing basket having a coffee beverage outlet through which the coffee beverage flows from said coffee brewing basket into said coffee reservoir;
a chiller adapted to chill the coffee beverage that flows from said coffee brewing basket into said coffee reservoir;
a pump to pump the coffee beverage within said coffee reservoir to said chiller by which the coffee beverage is chilled; and
tubing extending from said chiller to said coffee brewing basket so that the coffee beverage chilled by said chiller is pumped by said pump and circulated through said tubing to be returned to said coffee brewing basket to percolate through the ground coffee therewithin.

2. The cold brew coffee brewing system recited in claim 1, wherein the ground coffee that is placed in the coffee brewing basket of said cold brew coffee brewing machine is enclosed within a flow-through coffee package that is removable from said cold brew coffee brewing machine.

3. The cold brew coffee brewing system recited in claim 1, wherein said cold brew coffee brewing machine also comprises a stand by which to suspend said coffee brewing basket above said coffee reservoir.

4. The cold brew coffee brewing system recited in claim 3, wherein said cold brew coffee brewing machine also comprises a strainer located within said coffee reservoir so that the coffee beverage that is pumped from said coffee reservoir to said chiller flows through said strainer.

5. The cold brew coffee brewing system recited in claim 1, wherein the coffee beverage outlet of the coffee brewing basket of said cold brew coffee brewing machine is a funnel.

6. The cold brew coffee brewing system recited in claim 1, wherein said cold brew coffee brewing machine also comprises a coffee flow control valve located within said tubing to control the flow of the chilled coffee beverage that is pumped by said pump from said chiller and returned to said coffee brewing basket by way of said tubing.

7. The cold brew coffee brewing system recited in claim 1, wherein the tubing of said cold brew coffee brewing machine through which the chilled coffee beverage is pumped runs upwardly from said chiller so as to lie above said coffee brewing basket at which said tubing turns downwardly towards said coffee brewing basket so as to lie in spaced alignment therewith.

8. The cold brew coffee brewing system recited in claim 7, wherein said coffee brewing basket has a perforated top so that the chilled coffee beverage that is pumped by said pump from said chiller and through said downwardly turned tubing flows into said coffee brewing basket by way of the perforated top thereof.

9. The cold brew coffee brewing system recited in claim 8, wherein the tubing of said cold brew coffee brewing machine lies in a U-shaped coffee circulation path between said chiller and the perforated top of said coffee brewing basket.

10. The cold brew coffee brewing system recited in claim 9, wherein said U-shaped coffee circulation path runs from said chiller in a first direction so as to extend upwardly through the top of said cold brew coffee brewing machine and then in an opposite direction so as to extend downwardly through the top of said perked cold coffee brewing machine so as to lie in spaced axial alignment with the perforated top of said coffee brewing basket.

11. The cold brew coffee brewing system recited in claim 2, also including a centrifugal coffee beverage extractor having a rotatable coffee slurry container into which said removable flow-through package is relocated after said removable flow-through coffee package has been removed from said cold brew coffee brewing machine, said centrifugal coffee beverage extractor adapted to apply a spinning force to said rotatable coffee slurry container to cause said container to rotate and retained coffee beverage remaining in the mixture of ground coffee and water within said flow-through package to be centrifugally extracted therefrom.

12. The cold brew coffee brewing system recited in claim 11, wherein said centrifugal coffee beverage extractor also has a motor to generate the spinning force to be applied to said rotatable coffee slurry container to cause said container to rotate.

13. The cold brew coffee brewing system recited in claim 12, wherein said centrifugal coffee beverage extractor also has a motor shaft extending between said motor and said rotatable coffee slurry container such that the spinning force generated by said motor is applied to said rotatable coffee slurry container by way of said motor shaft.

14. The cold brew coffee brewing system recited in claim 12, wherein said centrifugal coffee beverage extractor also has a force dampener by which to reduce vibrations caused by the spinning force generated by said motor and applied to said rotatable coffee slurry container.

15. The cold brew coffee brewing system recited in claim 14, wherein said force dampener includes at least first and second springs coupled to said motor at opposite sides thereof.

16. The cold brew coffee brewing system recited in claim 11, wherein the rotatable coffee slurry container of said centrifugal coffee beverage extractor is perforated to enable the coffee beverage extracted from the mixture of ground coffee and water within said flow-through package to flow out of said coffee slurry container.

17. The cold brew coffee brewing system recited in claim 16, wherein the coffee slurry container of said centrifugal coffee beverage extractor is surrounded by a coffee pouring vessel having an outlet spout projecting therefrom, such that the coffee beverage that flows out of said perforated coffee slurry container flows into said coffee containment housing to be drained therefrom by way of said outlet spout.
